(19) United States
(12) Patent Application Publication
(10) Pub. No.: US 2007/0233405 A1
(43) Pub. Date: Oct. 4, 2007

(54) Computer program, apparatus, and method for analyzing electromagnetic waves

(75) Inventor: Hirotomo Izumi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/452,896

(22) Filed: Jun. 15, 2006

(30) Foreign Application Priority Data
Mar. 29, 2006 (JP) 2006-090034

(51) Int. Cl. G06F 19/00; G06F 17/40

(52) U.S. Cl. 702/57; 702/1; 702/75; 702/76; 702/77; 702/127; 702/189

(57) ABSTRACT

An electromagnetic wave analyzer that accurately calculates electromagnetic waves emanating from a given wave source, without the need for assessing accuracy in other than the wave source domain. An analysis condition receiver receives analysis conditions including position parameters specifying observation points, as well as frequency parameters specifying frequencies to be analyzed. Upon receipt of analysis conditions, a Fourier transform processor transforms time-series electromagnetic current data to produce frequency-specific electromagnetic current data for each frequency specified by the frequency parameters. Based on the frequency-specific electromagnetic current data, an electromagnetic field calculator calculates the electric field at each observation point specified by the position parameters, by integrating electric fields produced by electric and magnetic currents in each small volume of the electromagnetic wave source.

### CROSS-REFERENCE TO RELATED APPLICATIONS

This application is based upon, and claims the benefits of priority from, the prior Japanese Patent Application No. 2006-090034, filed Mar. 29, 2006, the entire contents of which are incorporated herein by reference.

### BACKGROUND OF THE INVENTION

1. Field of the Invention

The present invention relates to a computer program, an apparatus, and method for analyzing electromagnetic waves. More particularly, the present invention relates to a program stored in a computer-readable medium, an apparatus, and a method for analyzing electromagnetic waves at a point away from a wave source.

2. Description of the Related Art

The electromagnetic compatibility of electronic products is of increasing concern in recent years. To avoid problems, a prototype device has to be tested in a shielded room to measure its actual electromagnetic wave emission. Prototyping and testing steps are repeated until a satisfactory result is achieved. It is possible, however, to reduce such steps by using software tools that can simulate the emission of electromagnetic waves. The researchers have proposed various methods of electromagnetic wave analysis (see, for example, Japanese Unexamined Patent Application Publication No. 2004-239736).

One example of an electromagnetic wave analyzer uses integral equations derived from the Maxwell's equations, discretizes them into a system of simultaneous linear equations, and solves them to obtain an electromagnetic field distribution within an object under analysis. See, for example, the online literature titled “PLANC-DM2D Electromagnetic Wave Analysis Software” by NEC Corporation, which was found at http://www.sw.nec.co.jp /hpc/mediator/sxm_j/software/061.html on Mar. 13, 2006. The specifics of this method will now be described in the following paragraphs.

In general, electric and magnetic fields are calculated from vector potential and magnetic vector potential. Think of, for example, calculating an electric field in an analysis domain shown in FIG. 11. A wave source 91 emitting electromagnetic waves resides in a wave source domain 90, and an electric current element 92 is placed at the wave source 91, which means the presence of an electric current. Vector potential A(r) at a remote observation point 93 can then be expressed as follows:

$$A ( r ) = \int \frac{{μ}_{0} {J}_{1} ( {r}_{0} )}{4 π \vert r - {r}_{0} \vert} d {r}_{0} \qquad ( 1 )$$

where J₁(r₀) represents electric current data of the electric current element 92 at the wave source 91, r is a position vector representing the location of the observation point 93 relative to the coordinate origin, r₀ is a position vector representing the location of the electric current element 92, μ₀ is the vacuum permeability, and n is the ratio of the circumference of a circle to its diameter. This formula (1) means that the vector potential A(r) at a point |r| away from the origin can be obtained by summing up all influences of the electric current element 92 located at the wave source 91 and multiplying the result by some constant numbers including permeability.

With the vector potential A(r) of formula (1), the electric field E(r) is now calculated as follows:

$$E ( r ) = \frac{- iω}{{k}^{2}} graddiv A ( r ) - iω A ( r ) \qquad ( 2 )$$

where i represents the imaginary unit, ω is the angular velocity of the wave source 91, and k represents a proportionality constant (=¼πμ₀).

To calculate those formulas numerically, it is necessary to replace differentials with differences. This is achieved typically by using a central differencing method, which goes as follows. Think of the first derivative of a one-dimensional function A(x) at a point x=a. This is expressed in difference form as follows:

$$\frac{d A ( x )}{d x} \approx \frac{1}{2 Δ x} ( A ( a + 1 ) - A ( a - 1 ) ) \qquad ( 3 )$$

Likewise, the second derivative will be:

$$\begin{matrix}\frac{{d}^{2} A ( x )}{d {x}^{2}} \approx \frac{1}{( Δ x )} ( \frac{A ( a + 1 ) - A ( a )}{Δ x} - \frac{A ( a ) - A ( a - 1 )}{Δ x} ) \\ = \frac{1}{{( Δ x )}^{2}} ( A ( a + 1 ) - 2 A ( a ) + A ( a - 1 ) )\end{matrix} \qquad ( 4 )$$

While the above differencing scheme is applicable to Cartesian coordinate systems, the use of a polar coordinate system is preferable in the present case. Now let two variables a and b be the x and y coordinates of an observation point. The differencing operation at (a, b) is then given by:

$$\begin{matrix}\frac{{d}^{2} A ( x , y )}{d x d y} \approx \frac{1}{2 Δ y} ( \frac{A ( a + 1 , b + 1 ) - A ( a - 1 , b + 1 )}{2 Δ x} - \\ \frac{A ( a + 1 , b - 1 ) - A ( a - 1 , b - 1 )}{2 Δ x} ) \\ = \frac{1}{4 Δ y Δ x} ( A ( a + 1 , b + 1 ) - A ( a - 1 , b + 1 ) - \\ A ( a + 1 , b - 1 ) + A ( a - 1 , b - 1 ) )\end{matrix} \qquad ( 5 )$$

### The following shows the differential term of formula (2) in the form of polar coordinates.

$$grad Ψ = \frac{\partial Ψ}{\partial R} {a}_{R} + \frac{1}{R} \frac{\partial Ψ}{\partial θ} {a}_{θ} + \frac{1}{R sin θ} \frac{\partial Ψ}{\partial φ} {a}_{φ} \\ where Ψ = div A \\ div A = \frac{1}{{R}^{2}} \frac{\partial }{\partial R} ( {R}^{2} {A}_{R} ) + \frac{1}{R sin θ} \frac{\partial }{\partial θ} ( sin θ {A}_{θ} ) + \frac{1}{R sin θ} \frac{\partial }{\partial φ} {A}_{φ} \qquad ( 6 )$$

and where R represents the distance between the observation point and coordinate origin, and a_{R}, a_{θ}, and a₁₀₀ are radial and angular coordinate values of a point a.

As can be seen from the above, the vector potential at a given observation point is obtained by solving difference equations, and this vector potential gives an electric field at that point in question.

An electronic device containing a high-frequency circuit emits electromagnetic waves. This is generally undesirable because it could interfere with the operation of other electronic equipment or the like located near to the emitting device. Electronics engineers are supposed to design a device with an electromagnetic emission controlled within a certain limit. The resulting product is then subjected to an electromagnetic interference (EMI) test to determine whether it really complies with the target limit. It the test result is unsatisfactory, the design has to be changed to reduce the emission. Such prototyping and testing are repeated until the desired EMI suppression is achieved.

If it is possible to simulate the emission of electromagnetic waves from a primary source with a high accuracy, that will reduce the number of prototyping and redesigning cycles. However, many of the currently available electromagnetic analysis tools are only capable of simulating electromagnetic waves at an infinite distance from the source. This is because the assumption of an infinite distance makes it possible to simplify the computation algorithm by neglecting the terms that would not contribute to the electromagnetic field at a far distant point. Although the neglecting of such terms can be fully justified in the case of antenna analysis or the like, the simulation for an EMI test has to take those terms into consideration. It is theoretically possible to achieve the purpose by expanding the analysis domain to a sufficiently large space for EMI simulation. Such an expanded analysis domain, however, would increase the computational burden, making it difficult to simulate with an existing computer.

One way to address the above problem is to first calculate an electromagnetic field within a limited space containing the high-frequency circuit under test and its surroundings (referred to as “wave source domain”) and then proceed to the remaining space using the computational result of the wave source domain as already discussed above. This simulation technique, however, requires qualification of the results in terms of two kinds of accuracy errors. One accuracy error comes from the way of discretizing the wave source domain. The other accuracy error derives from the differencing of vector potentials outside the wave source domain.

FIGS. 12A and 12B show a wave source domain discretized with different grid intervals. More specifically, FIG. 12A shows a coarse discretization, and FIG. 12B shows a fine discretization. The coarse-grid wave source domain 90a of FIG. 12A reduces computational burden at the sacrifice of accuracy. On the other hand, the fine-grid wave source domain 90b of FIG. 12B produces more accurate results, but consumes more computational power.

FIG. 13 illustrates vector potential used to calculate electromagnetic waves at a remote observation point according to a conventional method. The vector potential at an observation point 93 with a distance of r is calculated from the vector potential at neighboring points 94 and 95 with distances of r−dr and r+dr, respectively. Since the way of selecting those points 94 and 95 would affect the calculated value of electromagnetic field at the observation point 93, the magnitude of dr should be carefully determined in order to ensure the convergence of solutions. That is, dr has to be adequately determined depending on variations of the electromagnetic field at the observation point 93. The variations, however, are not known before a simulation is actually conducted, meaning that one cannot find an optimal value of dr beforehand. It is therefore necessary to take a trial-and-error approach to determining dr, repeating simulation and evaluation steps with a new value of dr. This method, however, places a heavy workload on the users.

As can be seen from the above discussion, the existing methods are inconvenient to users since they need to verify the simulation accuracy for both inside and outside of a wave source domain. While it is not possible to skip the step of accuracy assessment within a wave source domain, the user's burden would be reduced if the assessment domain was confined to that region.

### SUMMARY OF THE INVENTION

In view of the foregoing, it is an object of the present invention to provide a computer program stored in a computer-readable medium, as well as an apparatus and method, that can analyze electromagnetic waves outside a wave source domain without the need for assessing accuracy in other than the wave source domain.

To accomplish the above object, the present invention provides a computer-readable medium storing a program for analyzing electromagnetic waves based on given electromagnetic current data. The program causes a computer to function as the following elements: an electromagnetic current data memory, an analysis condition receiver, a Fourier transform processor, and an electromagnetic field calculator. The electromagnetic current data memory stores time-series electromagnetic current data indicating how electric currents and magnetic currents in an electromagnetic wave source vary with time. The analysis condition receiver receives analysis conditions including position parameters and frequency parameters. The position parameters specify at least one observation point at which the electromagnetic field is to be analyzed, while the frequency parameters specify at least one frequency to be analyzed. When the analysis condition receiver receives analysis conditions, the Fourier transform processor performs a Fourier transform on the time-series electromagnetic current data to produce frequency-specific electromagnetic current data for each frequency specified by the frequency parameters. Based on the frequency-specific electromagnetic current data supplied from the Fourier transform processor, the electromagnetic field calculator that calculates an electric field at the observation point specified by the position parameters, by integrating electric fields produced by electric and magnetic currents in each small volume of the electromagnetic wave source.

Also, to accomplish the above object, the present invention provides an apparatus for analyzing electromagnetic waves based on given electromagnetic current data. This apparatus has the following elements: an electromagnetic current data memory, an analysis condition receiver, a Fourier transform processor, and an electromagnetic field calculator. The electromagnetic current data memory stores time-series electromagnetic current data indicating how electric currents and magnetic currents in an electromagnetic wave source vary with time. The analysis condition receiver receives analysis conditions including position parameters and frequency parameters. The position parameters specify at least one observation point at which the electromagnetic field is to be analyzed, while the frequency parameters specify at least one frequency to be analyzed. When the analysis condition receiver receives analysis conditions, the Fourier transform processor performs a Fourier transform on the time-series electromagnetic current data to produce frequency-specific electromagnetic current data for each frequency specified by the frequency parameters. Based on the frequency-specific electromagnetic current data supplied from the Fourier transform processor, the electromagnetic field calculator that calculates an electric field at the observation point specified by the position parameters, by integrating electric fields produced by electric and magnetic currents in each small volume of the electromagnetic wave source.

In addition, to accomplish the above object, the present invention provides a method of analyzing electromagnetic waves based on given electromagnetic current data. This method begins with receiving analysis conditions including position parameters and frequency parameters. The position parameters specify at least one observation point at which the electromagnetic field is to be analyzed, while the frequency parameters specify at least one frequency to be analyzed. The method also receives time-series electromagnetic current data indicating how electric currents and magnetic currents in an electromagnetic wave source vary with time. A Fourier transform is then performed on the time-series electromagnetic current data, thus producing frequency-specific electromagnetic current data for each frequency specified by the frequency parameters. The method calculates an electric field at the observation point specified by the position parameters, by integrating electric fields produced by electric and magnetic currents in each small volume of the electromagnetic wave source, based on the frequency-specific electromagnetic current data.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 gives an overview of an embodiment of the present invention.

FIG. 2 shows the distance between an electric current element and an observation point.

FIG. 3 shows an example hardware configuration of an electromagnetic wave analyzer according to the present embodiment.

FIG. 4 is a functional block diagram of an electromagnetic wave analyzer.

FIG. 5 is a flowchart of an electromagnetic wave analysis.

FIG. 6 shows an example data structure of electromagnetic current data.

FIG. 7 shows an example of analysis conditions.

FIG. 8 is a flowchart of electromagnetic field calculation.

FIG. 9 shows an example of an electromagnetic field data screen in text form.

FIG. 10 shows an example of an electromagnetic field data screen in graph form.

FIG. 11 shows a domain of analysis.

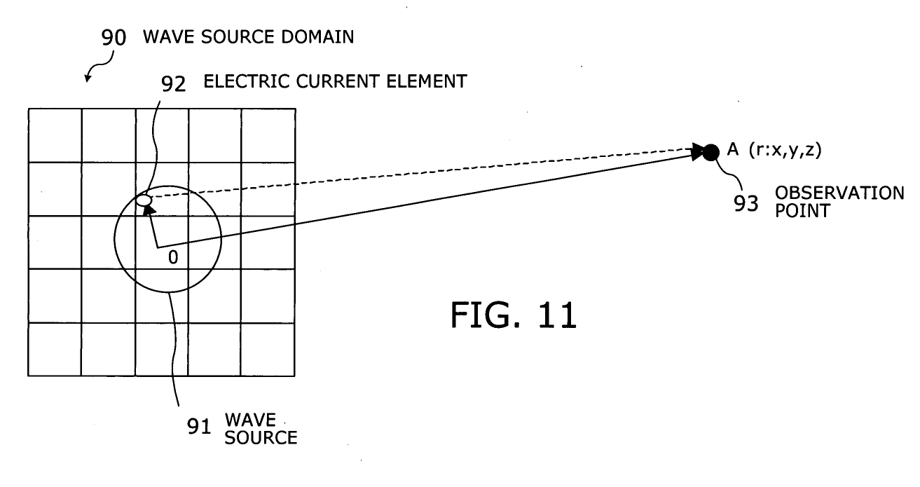

FIGS. 12A and 12B show a wave source domain discretized with different grid intervals, and more specifically, FIG. 12A shows a coarse-grid discretization and FIG. 12B a fine-grid discretization.

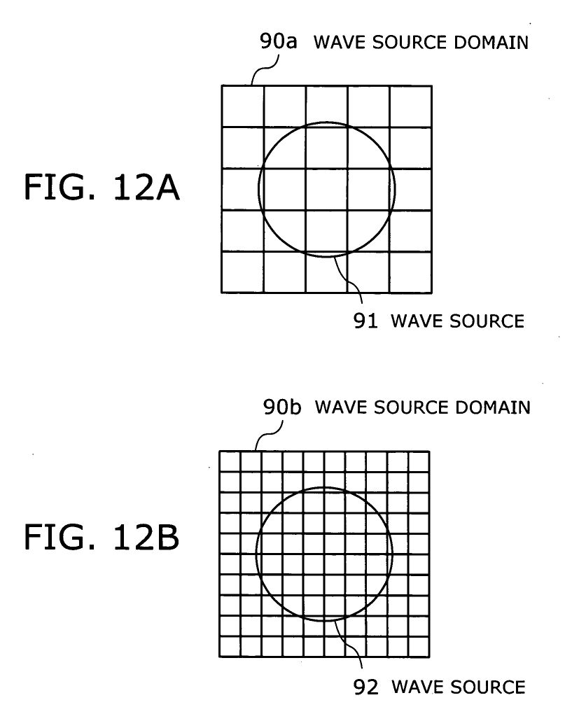

FIG. 13 illustrates vector potential used to calculate electromagnetic waves at an observation point according to a conventional method.

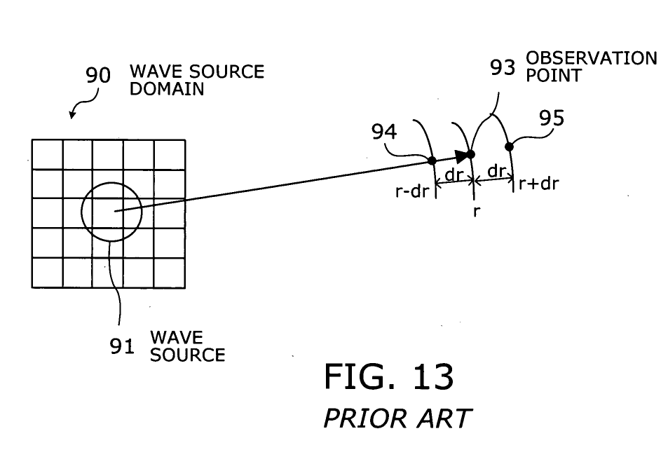

### DESCRIPTION OF THE PREFERRED EMBODIMENTS

Preferred embodiments of the present invention will be described below with reference to the accompanying drawings, wherein like reference numerals refer to like elements throughout.

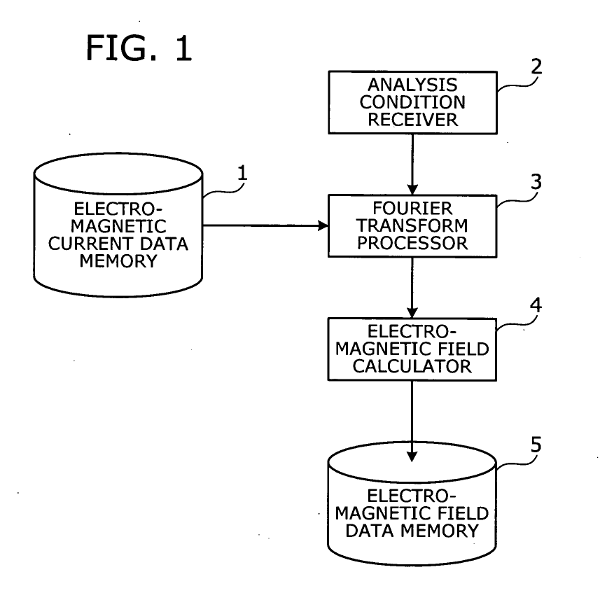

FIG. 1 gives an overview of an embodiment of the present invention. To calculate the electromagnetic field outside a given electromagnetic wave source, this embodiment provides the following elements: an electromagnetic current data memory 1, an analysis condition receiver 2, a Fourier transform processor 3, an electromagnetic field calculator 4, and an electromagnetic field data memory 5.

The electromagnetic current data memory 1 stores time-series electromagnetic current data indicating how electric and magnetic currents in an electromagnetic wave source (or simply, “wave source”) vary with time. The time-series electromagnetic current data is calculated with an existing technique for precise electromagnetic field analysis, such as a finite difference time domain (FDTD) method.

The analysis condition receiver 2 receives analysis conditions including position parameters and frequency parameters. Position parameters give one or more specific observation points at which the electromagnetic field is to be analyzed. Frequency parameters specify one or more frequencies to be analyzed. The received analysis conditions are passed to the Fourier transform processor 3.

When the analysis condition receiver 2 receives analysis conditions, the Fourier transform processor 3 makes access to the electromagnetic current data memory 1 to retrieve time-series electromagnetic current data. The Fourier transform processor 3 performs a Fourier transform on the retrieved time-series electromagnetic current data, thus producing frequency-specific electromagnetic current data for each different frequency specified by the frequency parameters. The resulting frequency-specific electromagnetic current data is then passed to the electromagnetic field calculator 4.

The electromagnetic field calculator 4 determines the position of a specified observation point by consulting the position parameters. The electromagnetic field calculator 4 calculates an electric field at the specified observation point by integrating electric fields produced by electric and magnetic currents in each small volume of the electromagnetic wave source, based on the frequency-specific electromagnetic current data supplied from the Fourier transform processor 3. Also based on the frequency-specific electromagnetic current data from the Fourier transform processor 3, the electromagnetic field calculator 4 further calculates a magnetic field at the observation point specified by the position parameters, by integrating magnetic fields produced by the electric and magnetic currents in each small volume of the wave source. The calculated electric and magnetic fields are then passed to the electromagnetic field data memory 5 as electromagnetic field data. The electromagnetic field data memory 5 stores this electromagnetic field data representing electric and magnetic fields at the observation point.

The above functions are implemented in an electromagnetic wave analyzing program for execution by a computer. In operation, the analysis condition receiver 2 receives analysis conditions including position parameters specifying an observation point, as well as frequency parameters specifying frequencies to be analyzed. When those analysis conditions are received, the Fourier transform processor 3 produces frequency-specific electromagnetic current data for each frequency specified by the frequency parameters. The electromagnetic field calculator 4 then integrates electric fields produced by electric and magnetic currents in each and every small volume constituting the entire wave source, thus obtaining an electric field at the observation point specified by the frequency parameters. The proposed algorithm eliminates the need for differencing the analysis domain and enables electric fields to be calculated with less computational burden.

The computational result of electromagnetic field is sometimes required to be presented in a polar coordinate system. To serve this need, the electromagnetic field calculator 4 may be configured to convert the coordinates to produce a polar coordinate version of electric field values at the observation point for each specified frequency.

The process of electromagnetic analysis consumes a considerable amount of memory space (primary storage space), particularly when a high accuracy is required. For efficient use of memory resources, the Fourier transform processor 3 is designed to save the space by actively releasing a memory space that is no longer necessary. More specifically, the Fourier transform processor 3 loads the memory with time-series electromagnetic current data to perform a Fourier transform on that memory data. When the transform is finished, the Fourier transform processor 3 releases the memory space of the time-series electromagnetic current data, while reading the resulting frequency-specific electromagnetic current data for use in a subsequent step.

The electromagnetic field calculator 4 can also use a similar memory saving method during the course of electromagnetic field analysis. More specifically, suppose that the given frequency parameters specify a plurality of frequencies. In this case, each time the electromagnetic field calculation is completed for one frequency, the electromagnetic field calculator 4 saves the calculated electric field data into a secondary storage device and releases the memory space that has been used to store electromagnetic current data of that frequency. It is therefore possible to calculate electromagnetic fields for many different frequencies without increasing the amount of memory capacity.

### Calculation of Electric Field

This section describes an integration algorithm used to calculate an electric field produced at a specific observation point by an electric current element. Electric and magnetic fields are calculated, in general, from vector potential and magnetic vector potential. The following description will focus on the calculation of electric field using a newly introduced virtual physical quantity called “magnetic current.” The magnetic current is often used in the field of radio engineering, and by using the term, the Maxwell's equations are rewritten as follows:

$$\begin{matrix}rot H = {ɛ}_{0} \frac{\partial E}{\partial t} + {J}_{1} & ( 7 ) \\ rot E = - {μ}_{0} \frac{\partial H}{\partial t} - {J}_{m 1} & ( 8 )\end{matrix}$$

where E represents electric field, H represents magnetic field, J₁ represents an electric current, Jₘ₁ represents a magnetic current, so is the dielectric constant of vacuum, and t represents simulation time.

Equation (7) is a normal form of Maxwell's equation. Equation (8), on the other hand, contains the aforementioned virtual physical quantity “magnetic current” as the second term on the right side, which has been introduced for the sake of symmetry with respect to equation (7). While the magnetic current cannot actually be measured as a real physical quantity, its use in solving Maxwell's equations in the above way is justifiable because it is known that the solution gives correct values of electromagnetic field.

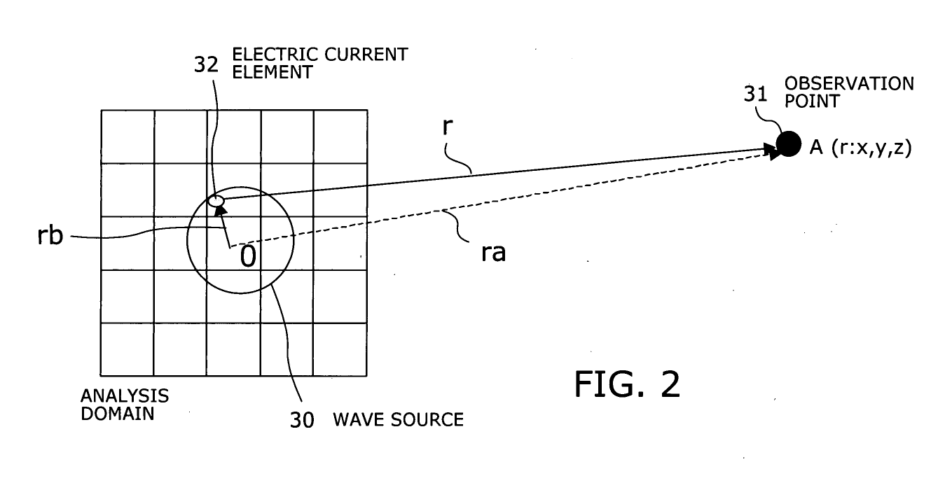

Referring now to FIG. 2, the distance between an electric current element and an observation point is calculated from their respective position vectors. Let rₐ be a position vector describing the spatial position of an observation point 31, and r_{b} be a position vector describing the spatial position of an electric current element 32 of a given wave source 30. Now think of a vector r from the electric current element 32 to the observation point 31. The observation distance |r| is then given by |r|=|rₐ−r_{b}|. The electric current element 32 produces a vector potential at the observation point 31, which is expressed as follows:

$$A ( r ) = \int \frac{{μ}_{0} {J}_{1} ( {r}_{b} )}{4 π r} d {r}_{b} \qquad ( 9 )$$

where J₁(r_{b}) represents an electric current of the wave source. The vector potential at the observation point 31 is then calculated by summing up all vector potential values derived from every electric current element constituting the wave source 30 and multiplying the resulting sum by some constant numbers including permeability. The resultant vector potential A(r) is used to describe the electric and magnetic fields as follows:

$$\begin{matrix}E ( r ) = \frac{- iω}{{k}^{2}} graddiv A ( r ) - iω A ( r ) & ( 10 ) \\ H ( r ) = \frac{1}{{μ}_{0}} rot A ( r ) & ( 11 )\end{matrix}$$

Similarly to the above, the magnetic vector potential is expressed as an integral of magnetic currents Jₘ₁(r_{b}) of the wave source 30.

$${A}_{m} ( r ) = \int \frac{{ɛ}_{0} {J}_{m 1} ( {r}_{b} )}{4 π r} d {r}_{b} \qquad ( 12 )$$

This equation (12) leads to the following formulas of electric and magnetic fields:

$$\begin{matrix}H ( r ) = \frac{- iω}{{k}^{2}} graddiv {A}_{m} ( r ) - iω {A}_{m} ( r ) & ( 13 ) \\ E ( r ) = \frac{1}{{ɛ}_{0}} rot {A}_{m} ( r ) & ( 14 )\end{matrix}$$

By combing the above formulas (10), (11), (13), and (14), the electromagnetic field can be expressed as:

$$\begin{matrix}E ( r ) = \frac{- iω}{{k}^{2}} graddiv A ( r ) - iω A ( r ) - \frac{1}{{ɛ}_{0}} rot {A}_{m} ( r ) & ( 15 ) \\ H ( r ) = \frac{1}{{μ}_{0}} rot A ( r ) - \frac{iω}{{k}^{2}} graddiv {A}_{m} ( r ) - iω {A}_{m} ( r ) & ( 16 )\end{matrix}$$

### Then, the following formula is obtained from (9), (12), and (15),

$$E ( r ) = \frac{- {iη}_{0}}{2 λ} \int \{ {J}_{1} - ( {J}_{1} \cdot {r}_{1} ) {r}_{1} \} \{ 1 + \frac{1}{i k r} + {( \frac{1}{i k r} )}^{2} \} - 2 ( {J}_{1} \cdot {r}_{1} ) {r}_{1} \{ \frac{1}{i k r} + {( \frac{1}{i k r} )}^{2} \} \frac{exp ( - i k r )}{r} d {r}_{b} + \frac{i}{2 λ} \int ( {J}_{m 1} \times {r}_{1} ) ( 1 + \frac{1}{i k r} ) \frac{exp ( - i k r )}{r} d {r}_{b} \qquad ( 17 )$$

and, from formulas (9), (12), and (16),

$$H ( r ) = \frac{- i}{2 {λη}_{0}} \int \{ {J}_{m 1} - ( {J}_{m 1} \cdot {r}_{1} ) {r}_{1} \} \{ 1 + \frac{1}{i k r} + {( \frac{1}{i k r} )}^{2} \} - 2 ( {J}_{m 1} \cdot {r}_{1} ) {r}_{1} \{ \frac{1}{i k r} + {( \frac{1}{i k r} )}^{2} \} \frac{exp ( - i k r )}{r} d {r}_{b} + \frac{i}{2 λ} \int ( {J}_{1} \times {r}_{1} ) ( 1 + \frac{1}{i k r} ) \frac{exp ( - i k r )}{r} d {r}_{b} \qquad ( 18 )$$

where λ represents the wavelength of an electromagnetic wave, η₀ is vacuum impedance (≈120π), r₁=−r_{b}/|r_{b}|, J₁=J₁(r_{b}), and r=|rₐ−r_{b}|.

It has to be noted that formulas (17) and (18) include no difference terms, which means that the calculation does not need electric field values at other points surrounding the observation point. For this reason, the electromagnetic field at any specified point can be calculated with a high accuracy and less computational burden, as long as the wave source domain is adequately discretized. The electric field of formula (17) can be converted into polar coordinates by calculating

$$[ \begin{matrix}{E}_{R} \\ {E}_{θ} \\ {E}_{φ}\end{matrix} ] = [ \begin{matrix}sin θcos φ & sin θsin φ & cos θ \\ cos θcos φ & cos θsin φ & - sin θ \\ - sin φ & cos φ & 0\end{matrix} ] [ \begin{matrix}{E}_{x} \\ {E}_{y} \\ {E}_{z}\end{matrix} ] \qquad ( 19 )$$

in the case where an (R, θ, φ) coordinate system is required. When an (R, θ, z) coordinate system is a preferred choice, the conversion is given by the following formula:

$$[ \begin{matrix}{E}_{R} \\ {E}_{θ} \\ {E}_{z}\end{matrix} ] = [ \begin{matrix}sin θcos φ & sin θsin φ & cos θ \\ cos θcos φ & cos θsin φ & - sin θ \\ 0 & 0 & 1\end{matrix} ] [ \begin{matrix}{E}_{x} \\ {E}_{x} \\ {E}_{z}\end{matrix} ] \qquad ( 20 )$$

As can be seen from the above description, the proposed algorithm obviates the need for the spatial differencing of vector potential, thus allowing the user to concentrate on the inside of the wave source domain when performing an accuracy assessment. The present embodiment thus reduces the user's burden in electromagnetic wave analysis.

### Electromagnetic Wave Analyzer

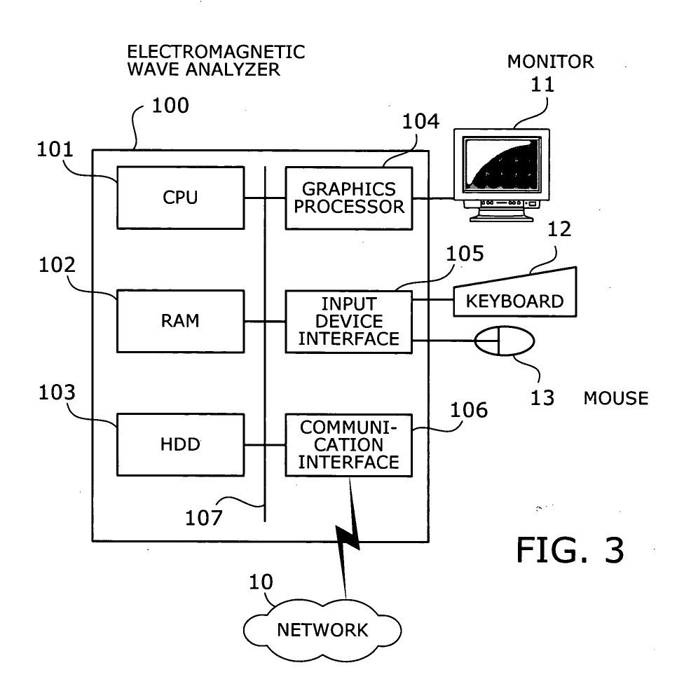

FIG. 3 shows an example hardware configuration of an electromagnetic wave analyzer 100 according to the present embodiment. This electromagnetic wave analyzer 100 has the following elements: a central processing unit (CPU) 101, a random access memory (RAM) 102, a hard disk drive (HDD) 103, a graphics processor 104, an input device interface 105, and a communication interface 106. The electromagnetic wave analyzer 100 is controlled entirely by the CPU 101, which interacts with other elements via a bus 107.

The RAM 102 temporarily stores at least a part of operating system (OS) programs and application programs that the CPU 101 executes, in addition to other various data objects manipulated at runtime. The HDD unit 103 stores program and data files of the operating system and applications.

The graphics processor 104 produces video images in accordance with drawing commands from the CPU 101 and displays them on the screen of a monitor 11 coupled thereto. The input device interface 105 is used to receive signals from external input devices, such as a keyboard 12 and a mouse 13. Those input signals are supplied to the CPU 101 via the bus 107. The communication interface 106 is connected to a network 10, allowing the CPU 101 to exchange data with other computers (not shown) on the network 10.

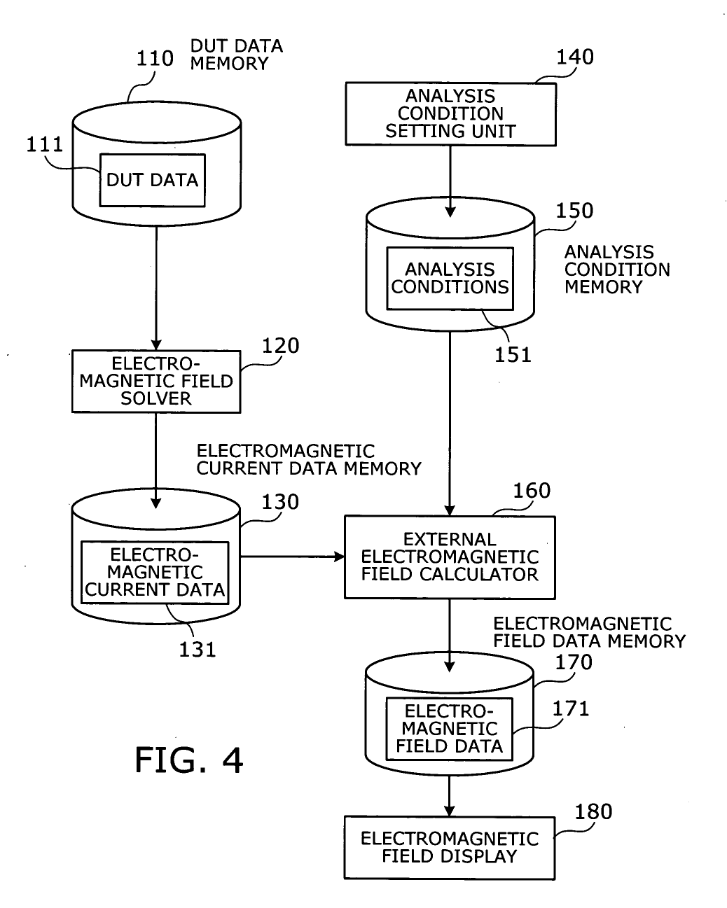

The present invention is embodied on the computer hardware platform described above. FIG. 4 is a functional block diagram of the electromagnetic wave analyzer 100. As FIG. 4 shows, the electromagnetic wave analyzer 100 is formed from a DUT data memory 110, an electromagnetic field solver 120, an electromagnetic current data memory 130, an analysis condition setting unit 140, an analysis condition memory 150, an external electromagnetic field calculator 160, an electromagnetic field data memory 170, and an electromagnetic field display 180.

The DUT data memory 110 stores DUT data 111 describing the physical structure and internal circuit of a device under test (DUT) whose external electromagnetic field is to be analyzed. Specifically, a part of the HDD 103 is assigned for this purpose.

The electromagnetic field solver 120 calculates electromagnetic waves in a specified analysis domain, based on the given DUT data 111. The analysis domain in this case is only within the device specified as a wave source and thus referred to as a wave source domain. The electromagnetic field solver 120 may use, for example, an FD-TD method to analyze the electromagnetic wave in the wave source domain, thereby producing electromagnetic current data 131. The electromagnetic field solver 120 stores the produced electromagnetic current data 131 in the electromagnetic current data memory 130. The aforementioned software tool “PLANC-DM2D” may be used as an electromagnetic field solver 120.

The electromagnetic current data memory 130 is a storage space for electromagnetic current data 131. Specifically, a part of the HDD 103 is assigned for this purpose.

The analysis condition setting unit 140 produces analysis conditions 151 according to commands from the user, for use in calculating external electromagnetic fields. The analysis condition setting unit 140 stores the produced analysis conditions 151 in the analysis condition memory 150.

The analysis condition memory 150 is a storage space for analysis conditions 151. Specifically, a part of the HDD 103 is assigned for this purpose.

The external electromagnetic field calculator 160 uses the analysis conditions 151 to calculate electromagnetic waves emanating from an electromagnetic wave source defined in the electromagnetic current data 131. Note that this calculation process does not involve differencing of vector potential. The external electromagnetic field calculator 160 stores the resulting electromagnetic field data 171 in the electromagnetic field data memory 170.

The electromagnetic field data memory 170 is a storage space for electromagnetic field data 171. Specifically, a part of the HDD 103 is assigned for this purpose.

The electromagnetic field display 180 displays the electromagnetic field outside the analysis domain in the form of a graph or the like, according to the electromagnetic field data 171.

### Process of Electromagnetic Wave Analysis

The electromagnetic wave analyzer 100 uses the functions described in the foregoing section to calculate electric and magnetic field leakage from the DUT. This section will describe the process in greater detail, assuming that a set of DUT data 111 has previously been prepared in the DUT data memory 110.

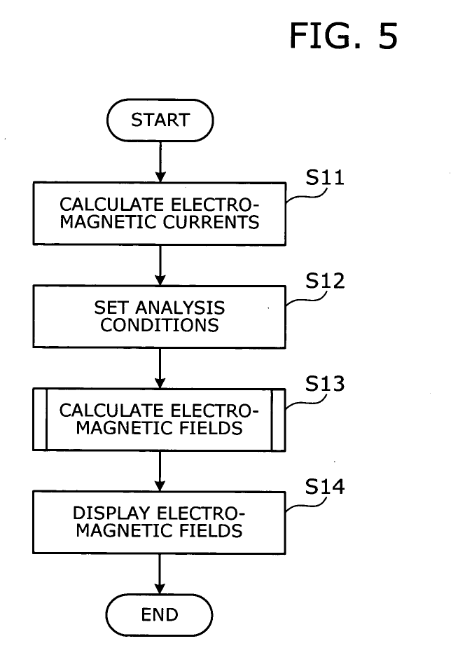

FIG. 5 is a flowchart of an electromagnetic wave analysis. This process is executed in the following steps:

(Step S11) Upon receipt of a console command from the user, the electromagnetic field solver 120 calculates electromagnetic currents within a device specified by the DUT data 111. The resulting electromagnetic current data 131 is then stored in the electromagnetic current data memory 130.

(Step S12) The analysis condition setting unit 140 creates analysis conditions 151 by interacting with the user. Specifically, the analysis condition setting unit 140 outputs an analysis condition setting dialog on the monitor 11 to allow the user to enter necessary parameters. The analysis condition setting unit 140 saves the received parameters in the analysis condition memory 150 for subsequent use as analysis conditions 151.

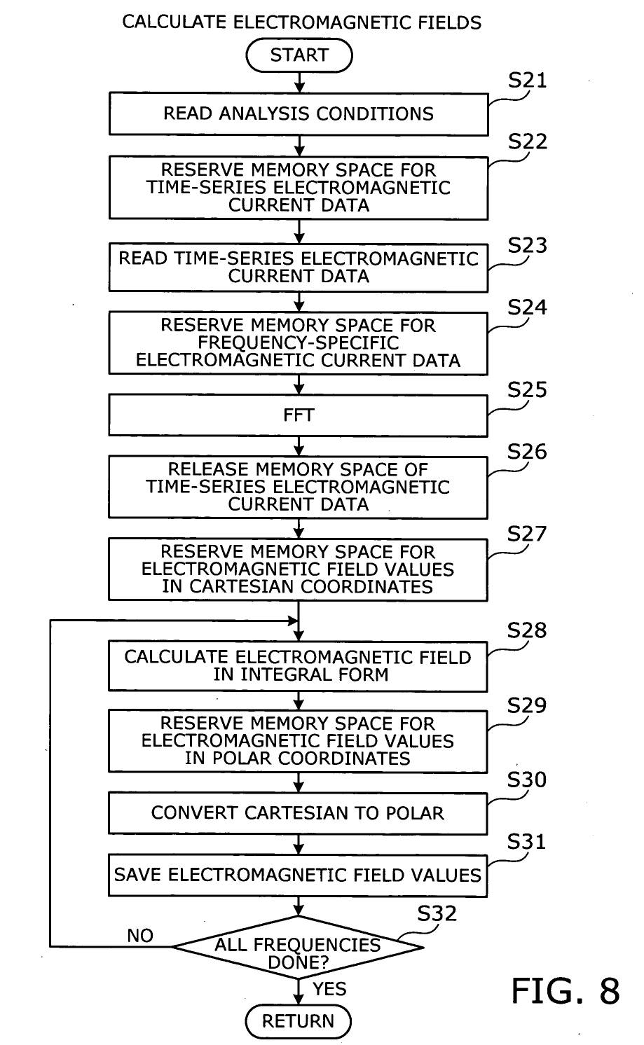

(Step S13) Each electromagnetic current given in the electromagnetic current data 131 produces an electromagnetic field outside the source device. The external electromagnetic field calculator 160 calculates this external electromagnetic field according to the given analysis conditions 151 and saves the result in the electromagnetic field data memory 170 as electromagnetic field data 171. The details of this step S13 will be described later with reference to FIG. 8.

(Step S14) Based on the electromagnetic field data 171, the electromagnetic field display 180 draws a graph or the like on a screen of the monitor 11 to visualize the calculated electric or magnetic field outside the DUT.

The design data of an electronic device under development is subjected to an electromagnetic simulation including the above steps before the real product undergoes an EMI test. Since electromagnetic current data 131 is created with a known computation technique, the following description will focus on the process subsequent to that computation.

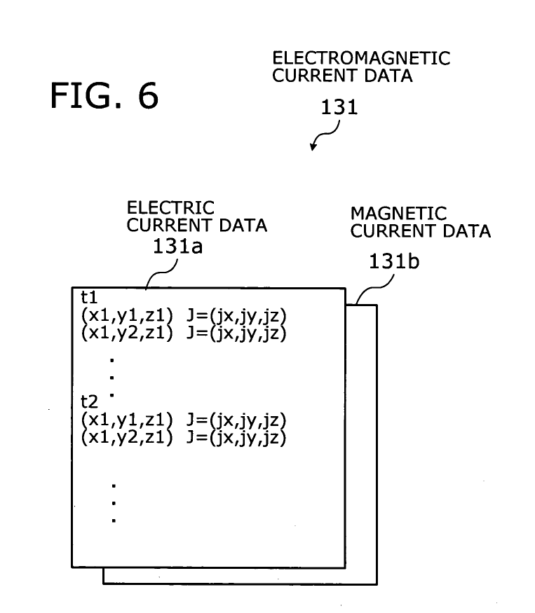

FIG. 6 shows an example data structure of electromagnetic current data 131. As can be seen, the electromagnetic current data 131 includes electric current data 131a and magnetic current data 131b. The wave source domain (i.e., the space of a device under test) is divided into small volumes called “cells.” The electric current data 131a is a collection of coordinate values and electric current values of each cell, arranged in the order of discretized time points (t1, t2, . . . ) of an FD-TD simulation. Likewise, the magnetic current data 131b is a collection of coordinate values and magnetic current values of each cell, arranged in the order of discretized time points (t1, t2, . . . ) of an FD-TD simulation.

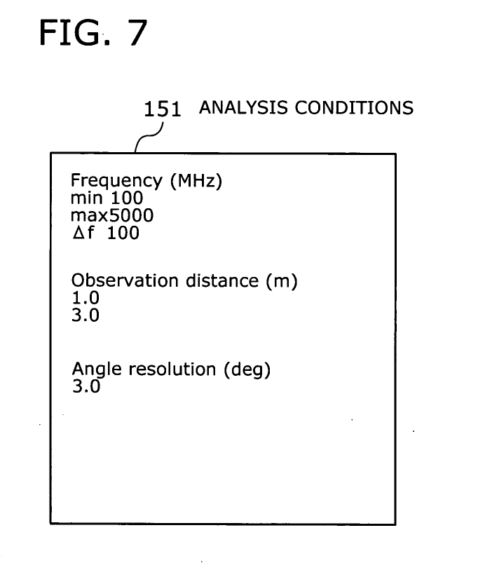

Now that the electromagnetic current data 131 of FIG. 6 is created, the analysis condition setting unit 140 sets analysis conditions 151 by interacting with the user. FIG. 7 shows an example of analysis conditions 151, which include parameters concerning the frequency, observation distance, and angle resolution. The observation distance parameters and angle resolution parameter define the positions of observation points. The frequency parameters include: minimum frequency (min), maximum frequency (max), and frequency step size (Δf). The analyzed frequency is increased during the course of analysis, beginning with the minimum frequency and going up to the maximum frequency with an increment of Δf.

More specifically, the observation distance parameters specify one or more observation distances relative to the origin. The angle resolution parameter indicates how many observation points are placed on an origin-centered circle with a radius specified by an observation distance parameter. The present example assumes that the observation points are placed on the circumference of a circle at equal intervals, and the angle resolution parameter designates the angle between two vectors representing two adjacent observation points. This means that a smaller angle resolution parameter gives a denser distribution of observation points.

### Electromagnetic Field Calculation

The analysis conditions 151 described in the preceding section are used in calculating external electromagnetic fields. FIG. 8 is a flowchart of this electromagnetic field calculation process, which includes the following steps:

(Step S21) Upon receipt of a console command requesting an electromagnetic field analysis, the external electromagnetic field calculator 160 reads analysis conditions 151 out of the analysis condition memory 150.

(Step S22) The external electromagnetic field calculator 160 reserves a part of the RAM 102 for use as a memory space of time-series electromagnetic current data 131.

(Step S23) The external electromagnetic field calculator 160 reads time-series electromagnetic current data 131 out of the electromagnetic current data memory 130 and sends it the memory space reserved at step S22.

(Step S24) The external electromagnetic field calculator 160 reserves another part of the RAM 102 for use as a memory space of frequency-specific electromagnetic current data.

(Step S25) The external electromagnetic field calculator 160 applies a fast Fourier transform (FFT) to the time-series electromagnetic current data 131, thus producing electromagnetic current data for each frequency component. The resulting frequency-specific electromagnetic current data is written in the memory space reserved at step S24.

(Step S26) The external electromagnetic field calculator 160 releases the memory space of the RAM 102 that has been used to store the time-series electromagnetic current data 131.

(Step S27) The external electromagnetic field calculator 160 reserves a part of the RAM 102 for use as a memory space of electromagnetic field values in Cartesian coordinates.

(Step S28) The external electromagnetic field calculator 160 selects one of the specified frequencies and calculates electromagnetic fields of the selected frequency by using integral formulas. More specifically, the external electromagnetic field calculator 160 uses the foregoing formulas (17) and (18) with an electric current J₁ and a magnetic current Jₘ₁ corresponding to the selected frequency. The resulting electromagnetic field values at each observation point are written in the memory space reserved at step S27.

(Step S29) The external electromagnetic field calculator 160 reserves a part of the RAM 102 for use as a memory space of electromagnetic field values in polar coordinates.

(Step S30) The external electromagnetic field calculator 160 converts the electromagnetic field values of step S28 into polar coordinates. More specifically, the external electromagnetic field calculator 160 uses formula (19) or formula (20) to convert the values of Eₓ, E_{y}, and E_{z} at each observation point. The resulting electromagnetic field values are written in the memory space reserved at step S29.

(Step S31) The external electromagnetic field calculator 160 transfers electric field values and magnetic field values from the memory space reserved at step S29 to the electromagnetic field data memory 170, and it then releases the reserved memory space.

(Step S32) The external electromagnetic field calculator 160 determines whether the analysis has been done for all the specified frequencies. If there are any remaining frequencies, the external electromagnetic field calculator 160 goes back to step S28 to select a new frequency. If all frequencies are done, the external electromagnetic field calculator 160 exits from the process of FIG. 8.

### Output of Electromagnetic Field Data

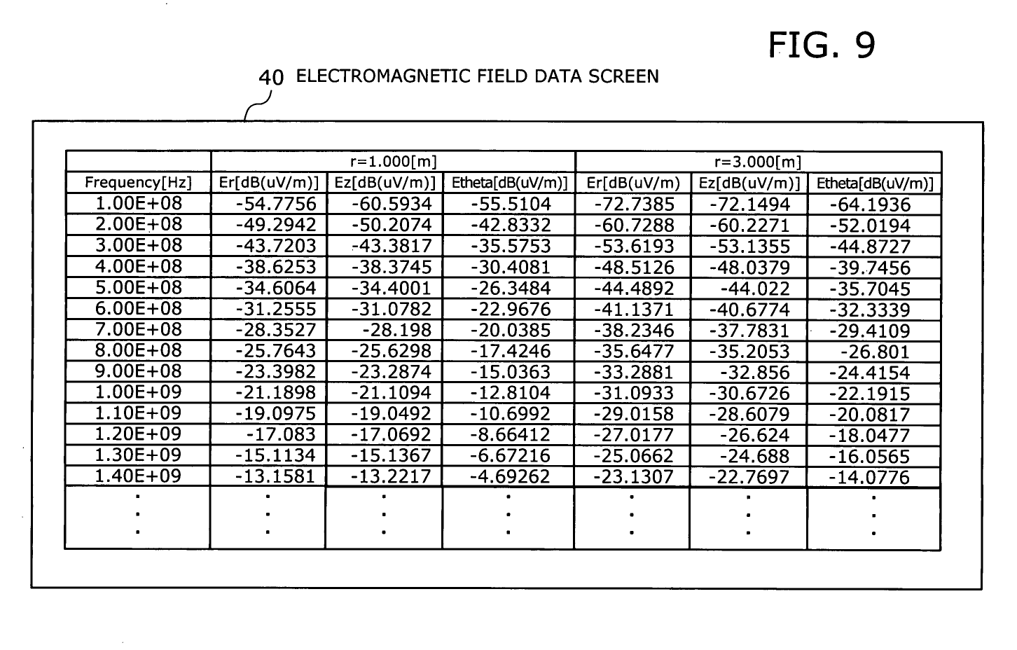

The produced electromagnetic field data 171 is passed to the electromagnetic field display 180 for display on the monitor 11. FIG. 9 shows an example of an electromagnetic field data screen on which the data is presented in text form. In this example, the electromagnetic field data screen 40 shows electric field values Eᵣ, E_{z}, and E_{θ} (Etheta in FIG. 9) in polar coordinates, for each combination of frequencies and observation distances (1 m and 3 m).

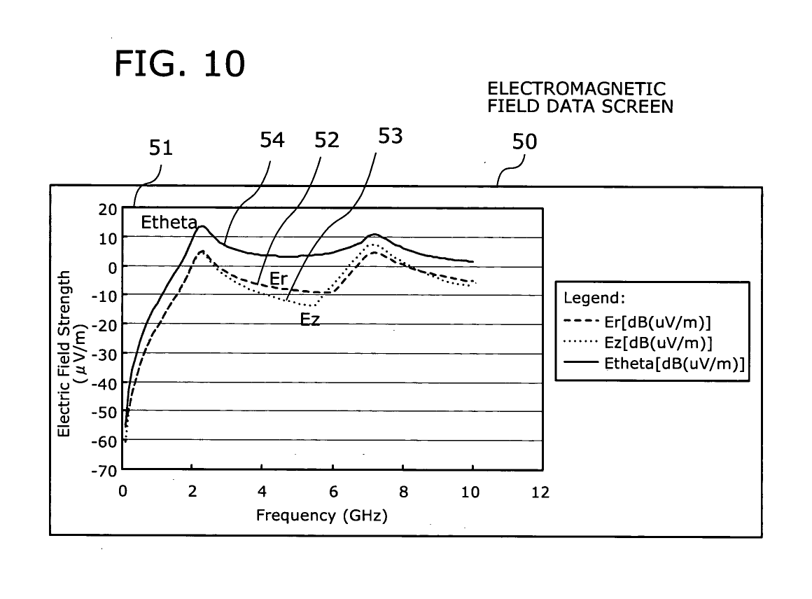

FIG. 10 shows another example of an electromagnetic field data screen, on which the data is presented in graph form. In this example, the electromagnetic field data screen 50 contains a graph 51 with a horizontal axis representing frequency (GHz) and a vertical axis representing electric field strength (μV/m). The graph 51 includes three curves 52, 53, and 54 to show how the components Eᵣ, E_{z}, and E_{θ} (Etheta in FIG. 10) vary with frequency.

### Computer-readable Storage Medium

The above-described processing mechanisms of an electromagnetic wave analyzer are actually implemented as software functions of a computer system, the instructions being encoded and provided in the form of computer programs. A computer system executes those programs to provide the intended functions of the present invention. The programs are stored in a computer-readable medium for the purpose of storage and distribution. Suitable computer-readable storage media include magnetic storage media, optical discs, magneto-optical storage media, and solid state memory devices. Magnetic storage media include hard disk drives (HDD), flexible disks (FD), and magnetic tapes. Optical discs may include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for circulation of computer programs. Network-based distribution of software programs is also possible, in which the program files stored in a server computer are downloaded to client computers via the network.

The computer system stores the above programs in its local storage unit, which have been previously installed from a portable storage media or downloaded from a remote server computer. The computer provides the intended functions by executing the programs read out of the local storage unit. As an alternative way of program execution, the client computer may execute the programs directly from a portable storage medium. Another alternative method is that the server computer supplies a client computer with the programs dynamically, allowing it to execute them upon delivery.

### Conclusion

In summary, the present invention calculates electric field at an observation point away from a wave source by integrating electric fields produced by electric and magnetic currents within each small volume of the wave source domain. This method eliminates the need for assessing accuracy in terms of discretization of the wave source domain, thus reducing the user's burden.

The use of integral formulas offers an accurate calculation result of electromagnetic fields outside the wave source domain as long as the wave source domain has been accurately analyzed. The analyzer can thus produce an accurate output with a smaller amount of computation and in a shorter time. Since the electromagnetic field at individual observation points can be calculated without reference to their surrounding points, the amount of computational load will decrease in proportion to the number of observation points. The FD-TD method calculates waves across an entire space between the wave source domain and observation point to solve the Maxwell's equations with temporal and spatial differencing. In contrast, the method of the present embodiment takes advantage of integral form, thus calculating the electromagnetic field directly at that point with a smaller amount of computation.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A computer-readable medium storing a program for analyzing electromagnetic waves based on given electromagnetic current data, the program causing a computer to function as:
an electromagnetic current data memory that stores time-series electromagnetic current data indicating how electric currents and magnetic currents in an electromagnetic wave source vary with time;
an analysis condition receiver that receives analysis conditions including position parameters and frequency parameters, the position parameters specifying at least one observation point at which an electromagnetic field is to be analyzed, the frequency parameters specifying at least one frequency to be analyzed;
a Fourier transform processor that performs a Fourier transform on the time-series electromagnetic current data to produce frequency-specific electromagnetic current data for each frequency specified by the frequency parameters, when the analysis condition receiver receives analysis conditions; and
an electromagnetic field calculator that calculates an electric field at the observation point specified by the position parameters, by integrating electric fields produced by electric and magnetic currents in each small volume of the electromagnetic wave source, based on the frequency-specific electromagnetic current data supplied from the Fourier transform processor.

2. The computer-readable medium according to claim 1, wherein the electromagnetic field calculator further calculates a magnetic field at the observation point specified by the position parameters by integrating magnetic fields produced by the electric and magnetic currents in each small volume of the electromagnetic wave source, based on the frequency-specific electromagnetic current data supplied from the Fourier transform processor.

3. The computer-readable medium according to claim 1, wherein the electromagnetic field calculator converts values of the calculated electric field into polar coordinate form.

4. The computer-readable medium according to claim 1, wherein the Fourier transform processor loads a memory space with the time-series electromagnetic current data to perform a Fourier transform thereon and, when the Fourier transform is finished, releases the memory space of the time-series electromagnetic current data while reading the resulting frequency-specific electromagnetic current data.

5. The computer-readable medium according to claim 1, wherein:
the frequency parameters specify a plurality of frequencies; and
each time the calculation of electric field is completed for one frequency, the electromagnetic field calculator saves the calculated data of electric field into a secondary storage device and releases a memory space that has been used to store the frequency-specific electromagnetic current data of that frequency.

6. An apparatus for analyzing electromagnetic waves based on given electromagnetic current data, the apparatus comprising:
an electromagnetic current data memory that stores time-series electromagnetic current data indicating how electric currents and magnetic currents in an electromagnetic wave source vary with time;
an analysis condition receiver that receives analysis conditions including position parameters and frequency parameters, the position parameters specifying at least one observation point at which an electromagnetic field is to be analyzed, the frequency parameters specifying at least one frequency to be analyzed;
a Fourier transform processor that performs a Fourier transform on the time-series electromagnetic current data to produce frequency-specific electromagnetic current data for each frequency specified by the frequency parameters, when the analysis condition receiver receives analysis conditions; and
an electromagnetic field calculator that calculates an electric field at the observation point specified by the position parameters, by integrating electric fields produced by electric and magnetic currents in each small volume of the electromagnetic wave source, based on the frequency-specific electromagnetic current data supplied from the Fourier transform processor.

7. A method of analyzing electromagnetic waves based on given electromagnetic current data, the method comprising:
receiving analysis conditions including position parameters and frequency parameters, the position parameters specifying at least one observation point at which an electromagnetic field is to be analyzed, the frequency parameters specifying at least one frequency to be analyzed;
receiving time-series electromagnetic current data indicating how electric currents and magnetic currents in an electromagnetic wave source vary with time;
performing a Fourier transform on the time-series electromagnetic current data to produce frequency-specific electromagnetic current data for each frequency specified by the frequency parameters; and
calculating an electric field at the observation point specified by the position parameters, by integrating electric fields produced by electric and magnetic currents in each small volume of the electromagnetic wave source, based on the frequency-specific electromagnetic current data, and providing values of the electric field calculated.
